(19) United States
(12) Patent Application Publication
(10) Pub. No.: US 2019/0255593 A1
(43) Pub. Date: Aug. 22, 2019

(54) METHOD AND APPARATUS FOR TRIMMING A CAN

(71) Applicant: BELVAC PRODUCTION MACHINERY, INC., Lynchburg, VA (US)

(72) Inventors: Gerald Meador, Hardy, VA (US); Nageswara Rao Nagisetty, Lynchburg, VA (US)

(21) Appl. No.: 16/345,805

(22) PCT Filed: Oct. 31, 2017
(86) PCT No.: PCT/US2017/059349

§ 371 Date: Apr. 29, 2019

Related U.S. Application Data
(60) Provisional application No. 62/419,234, filed on Nov. 8, 2016.

(51) Int. Cl. B21D 51/26; B23B 25/02; B23B 5/16; B23C 3/12

(52) U.S. Cl. CPC B21D 51/2615; B23B 25/02; B23B 5/168; B23C 2220/40; B23B 2222/04; B23B 2260/02; B23C 3/12

(57) ABSTRACT

A cam for use in trimming earing from an open end of an article following at least one forming process. The cam includes a cam profile for actuating a cam follower to which the article is coupled. The cam profile includes a generally sloped rising portion, a generally sloped retracting portion, and a working portion bridging the rising portion and the retracting portion. The working portion includes generally sloped sections separated by at least one recess or dwell.

### CROSS-REFERENCE TO RELATED APPLICATIONS

This application claims priority to U.S. Provisional Patent Application No. 62/419,234, filed Nov. 8, 2016, which is hereby incorporated by reference herein in its entirety.

### TECHNICAL FIELD

The present disclosure relates generally to systems, methods, and devices for forming or processing an article of manufacture. More particularly, aspects of this disclosure relate to methods and apparatus for trimming articles or containers, such as bottles and cans.

### BACKGROUND

In the container manufacturing industry, various approaches exist for fabricating and processing different container constructions, including bottles, cans, jars, and the like. An example of a machine that forms the shape of a can body is known as a “necker” apparatus. A necker is a type of tool-and-die apparatus in which sheet metal is placed between a tool having a protrusion and a die having a matching indentation. The tool and die are brought together under pressure, forcing the sheet metal to assume the shape of the protrusion-indentation. Conventional neckers operate by applying mechanical pressure to the can body after it has been formed into its general body shape, e.g., a cylinder or multi-angular shape with an integral bottom wall. The BELVAC™ (Belvac Product Machinery, Inc., Lynchburg, Va.) 595 Shaped Can Necker, for example, may form can bodies at speeds of up to approximately 2,500 cans per minute. Can bodies are squeezed (“necked”) between opposite moving ram assemblies, namely a series of push ram assemblies that act as tools, and an opposite series of knockout rams that act as dies. As the can bodies are progressed through the machine, they are rapidly squeezed between a first pair of push and knockout rams, then a second pair of push and knockout rams, for as many as six or eight or more pairs of rams to complete the “necking” operation.

As a can (or other container) is necked, the shape of the top of the container (at or near the edge of the opening) typically becomes wavy (instead of being level and circular) and/or includes other small defects. The “wavy” portion of the container is referred to as “earing,” which is a condition caused by the continuous forming or necking of the container. Specifically, earing refers to high and low points relative to the material grain direction. Typically, the smaller the opening of the can with respect to its original size, the more reductions or necking operations are required and, accordingly, the wavier the top edge of a can becomes. Waviness along the edge of the opening is generally not a desirable feature and, in fact, can cause various problems with subsequent can production operations such as, for example, edge rolling and/or threading. To address this, the container is typically trimmed, removing a small amount of the earing, or material from the top edge, which creates a more pristine edge for subsequent forming processes.

During the trimming process, a sharp trimming tool positioned within a trimming chamber contacts the edge of the container, and as the trimming tool is rotated, a portion of the wavy edge along the opening of the can is trimmed. As the material from the earing is removed, it may spiral away from the cut edge of the container. The material, which is usually malleable (e.g., aluminum) generally forms a long and “stringy” thin shaving or chip. The length and size of the shaving or chip generally depend on factors such as the material thickness, rate of feed, diameter of the container, amount of material being removed, combinations thereof, or the like. In one example, a container having a diameter of about 1.67 inches may result in a shaving or chip having a length up to about 15 inches long. As such long chips are evacuated from the trimming chamber, they tend to accumulate, thereby causing clogging at the trimming tool and along the evacuation passage. A convenient chip shape would be, e.g., small curls that can be easily evacuated with a vacuum system, as compared to long strings that could catch and tangle.

Thus, it would be desirable to create an apparatus and methods for producing shorter shavings or chips to reduce accumulation and/or clogging of the trimming tool and the evacuation passage.

### SUMMARY

According to one embodiment disclosed herein, a processing turret is disclosed. The processing turret comprises a trimmer head and a cam. The cam includes a cam profile having a generally sloped rising portion, a generally sloped retracting portion, and a working portion bridging top ends of the rising portion and the retracting portion. The working portion includes generally sloped sections separated by at least one recess or dwell therein. The processing turret further includes a push ram assembly for moving an article. A first end of the push ram assembly includes a feature for holding an article. The processing turret further includes a cam follower coupled to the push ram assembly at or near a second end of the push ram assembly. The cam follower is configured to be actuated by the cam. The trimmer head is configured to remove a first chip portion from an open end of the article when the cam follower contacts the generally sloped sections of the working portion of the cam, and the first chip portion is configured to be detached from the article when the cam follower contacts the at least one recess or dwell.

According to another embodiment disclosed herein, a cam for use in trimming earing from an open end of an article following at least one forming process is disclosed. The cam includes a cam profile for actuating a cam follower to which the article is coupled. The cam profile includes a generally sloped rising portion, a generally sloped retracting portion, and a working portion bridging the rising portion and the retracting portion. The working portion includes generally sloped sections separated by at least one recess or dwell.

According to one method disclosed herein, a method of trimming earing from an open end of an article is disclosed. The method includes moving a push ram assembly having the article coupled to a first end thereof a first distance in a first direction such that the article contacts a trimmer head. The moving results from a cam follower coupled to a second end of the push ram assembly moving along a generally sloped rising portion of the profile of a cam. The cam profile further includes a generally sloped retracting portion and a working portion bridging top ends of the rising portion and the retracting portion. The working portion includes generally sloped sections separated by at least one recess or dwell. The method further includes rotating at least one of the article or the trimmer head such that the trimmer head removes a first chip portion from the open end of the article. The removing occurs when the cam follower moves along a first section of the working portion of the cam profile. The method further includes halting the movement of the push ram assembly in the first direction via the cam follower contacting the at least one recess or dwell in the working portion of the cam profile. The halting causes the first chip portion to detach from the article. The method further includes moving the push ram assembly having the article coupled thereto in the first direction via the cam follower contacting a second section of the working portion of the cam profile. The method further includes rotating at least one of the article or the trimmer head such that the trimmer head removes a second chip portion from the open end of the article. The removing occurs when the cam follower moves along the second section of the working portion of the cam profile. The method further includes halting the movement of the push ram assembly in the first direction via the cam follower contacting a second recess or dwell in the working portion or the retracting portion of the cam profile. The halting causes the second chip portion to detach from the article.

The above summary does not represent every embodiment or every aspect of the present disclosure. Rather, the foregoing summary merely provides an exemplification of some of the novel aspects and features set forth herein. The above features and advantages and other features and advantages of the present disclosure, which are considered to be inventive singly or in any combination, will be readily apparent from the following detailed description of the illustrated examples and the modes for carrying out the present invention when taken in connection with the accompanying drawings and the appended claims.

### BRIEF DESCRIPTION OF THE DRAWINGS

FIG. 1 is a depiction of a trimmer head according to one embodiment.

FIG. 2A is a perspective view of the trimmer head of FIG. 1.

FIG. 2B is a side view of the trimmer head of FIGS. 1 and 2A.

FIG. 2C is a front view of the trimmer head of FIGS. 1, 2A, and 2B.

FIG. 3A is a front view of a non-limiting example of a container that may be used with the embodiments discussed herein.

FIG. 3B is a close-up view of the top edge of the container of FIG. 3A.

FIG. 4A depicts a front-view of a trimmer machine according to one embodiment.

FIG. 4B depicts a cross-sectional view of the trimmer machine of FIG. 4A, wherein a trimming turret may be seen.

FIG. 5A depicts a cross-sectional view of a trimming turret according to one embodiment.

FIG. 5B depicts another cross-sectional view of a trimming turret according to one embodiment.

FIG. 5C depicts another cross-sectional view of a trimming turret according to one embodiment.

FIG. 6A depicts a side view of a trimming turret according to one embodiment.

FIG. 6B depicts a cross-sectional view of a trimming turret according to one embodiment.

FIG. 6C depicts a perspective view of a trimming turret according to one embodiment.

FIG. 6D depicts a front view of a trimming turret according to one embodiment.

FIG. 7 depicts an isometric view of a trimmer machine according to one embodiment.

FIG. 8 depicts an isometric view of a portion of a trimmer machine according to one embodiment.

FIG. 9 depicts a spindle assembly according to one embodiment.

FIG. 10A is a perspective view of an exemplary pulsing cam according to embodiments disclosed herein.

FIG. 10B is a close-up view of a working portion of the profile of the pulsing cam of FIG. 10A according to one embodiment.

FIG. 10C is a graph illustrating the displacement of the profile of the pulsing cam of FIGS. 10A, 10B around the circumference (by degree) of the pulsing cam.

FIG. 10D illustrates alternative close-up views of Section C of FIG. 10C according to non-limiting embodiments.

FIG. 10E illustrates a close-up view of Section D of FIG. 10D.

The present disclosure is susceptible to various modifications and alternative forms, and some representative embodiments have been shown by way of example in the drawings and will be described in detail herein. It should be understood, however, that the inventive aspects are not limited to the particular forms illustrated in the drawings. Rather, the disclosure is to cover all modifications, equivalents, and alternatives falling within the spirit and scope of the invention as defined by the appended claims.

### DETAILED DESCRIPTION OF ILLUSTRATED EXAMPLES

This disclosure is susceptible of embodiment in many different forms. There are shown in the drawings, and will herein be described in detail, representative embodiments, with the understanding that the present disclosure is to be considered as an exemplification of the principles of the present disclosure and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed or logically prohibited, the singular includes the plural and vice versa, and the words “including,” “comprising,” or “having” mean “including without limitation.” Moreover, words of approximation, such as “about,” “almost,” “substantially,” “approximately,” and the like, can be used herein in the sense of, for example, “at, near, or nearly at,” or “within 3-5% of,” or “within acceptable manufacturing tolerances,” or any logical combination thereof. The drawings are provided for illustration purposes, and the features shown therein are not necessarily to scale.

A trimming device, as described herein, may be a separate machine or one machine in a machine line. Before discussing the specifics of the trimming device contemplated by the present disclosure, a brief description of a machine line according to one embodiment will be briefly described.

In an exemplary machine line, an article, such as an embryonic aluminum can or other stress induced plastically deformed container, is first fed into a first machine to fill stations in a turret/star wheel. Each star wheel may have any number of stations to hold articles for processing or transfer. For example, a star wheel may have six, eight, or ten stations to hold six, eight, or ten articles, respectively. It will be recognized that the star wheel is capable of having from one station to any suitable number of stations.

The article is then processed through any number of stages, one or more of which may be a necking stage and one or more of which may be a trimming stage. When all process/forming stages are complete, the article is discharged from the machine. The machine line may be a recirculating machine line or any other type of machine line.

In one exemplary scenario, after a first set of necking operations and a first trimming operation in a trimming turret of a trimming device (described below in greater detail) is completed, the article (e.g., a can) is recirculated by a recirculating machine back to the beginning of the machine line to be subjected to further necking operations in a “second pass” (the first set of necking and trimming being done in the “first pass”), as described above. That is, after the cans are loaded in a primary end feed, the cans come into the machine that will go through the first pass tooling and be subjected to, for example, 17 reductions (the can is necked 17 times). The cans may then travel through a recirculating conveyor and then be returned and loaded in the second pass pockets on the trimming turret. In some embodiments, the cans go through exactly the same turrets, but are subjected to a different set of tooling in the turret for the second pass, as will be discussed in greater detail below.

In some embodiments, there is a trimmer immediately at the end of the “necker” tooling, which trims after the first pass. The trimmer may also trim after the second pass in the same turret. This allows for two different opening diameters to be trimmed within one trimming turret.

It is noted that in other embodiments, there may also or alternatively be a trimming turret after a threading turret that imparts threads onto a container. The trimming turret may be used to trim the can after the threads are imparted onto the container.

Various aspects of the trimming device, which may be utilized in the line just described, will now be discussed.

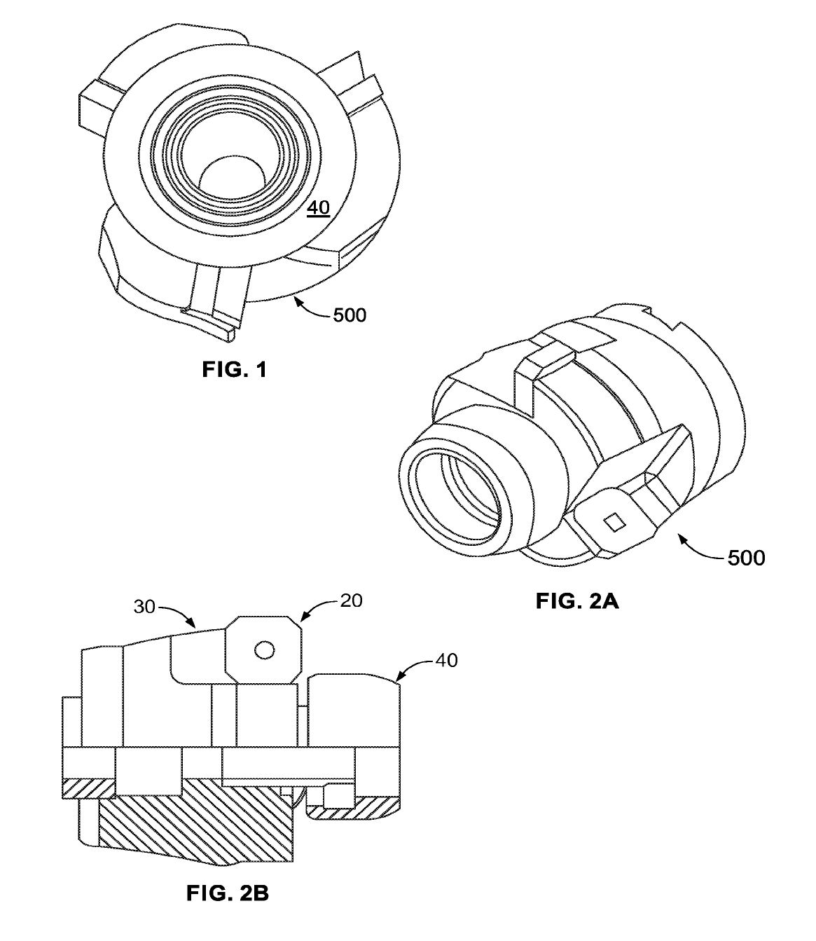

Referring to FIGS. 1-2C, a trimmer head 500 is shown according to one embodiment. The trimmer head 500 includes blade inserts 20 that are mounted onto a cutter chassis 30. The blade inserts 20 may be designed to be replaceable with respect to the body of the trimmer head 500. By way of example only and not by way of limitation, a hex bolt or other type of bolt or other attachment means may be used to attach the blades to the body of the trimmer head 500 such that the blades may be replaced as the blades become worn through use.

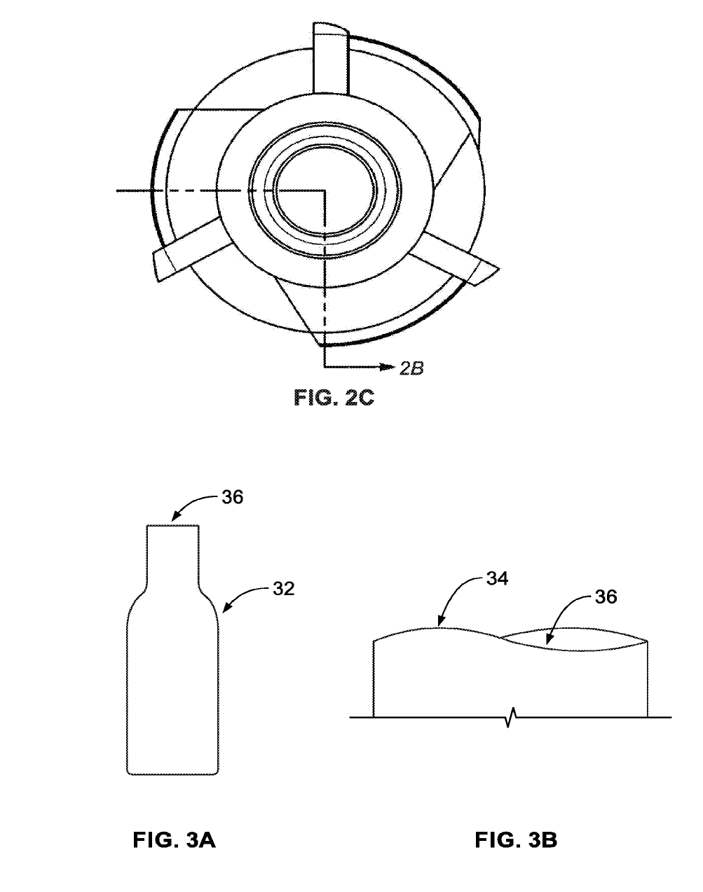

FIGS. 3A-3B illustrate an exemplary bottle can 32 having a wavy portion/earing 34 at a top edge near an open end or opening 36. As discussed above, the wavy portion/earing 34 is generally created via one or more necking processes. A peak-to-valley distance 37 of the top edge can range, for example, from about 0.005 inches to about 0.025 inches.

Referring back to FIGS. 1-2C, the trimmer head 500 also includes a trimmer pilot 40. In some embodiments, the outer diameter and the dimensions of the pilot 40 are sized such that the trimmer head 500 may be roughly centered with respect to the opening 36 of the bottle or can 32 during trimming of the wavy portion/earing 34. That is, the pilot 40, in some embodiments, is of different sizes for different trimmers 500. In particular, referring to the above-described multi-series necking scenario, a pilot having a larger outer diameter would be utilized on a trimmer 500 for trimming bottles/cans that have undergone the first series of necking operations but would generally not be suitable for use for a second series of operations because the opening at the top of the can/bottle would be larger after the first pass than the opening of the can/bottle after the next series of necking operations, whether in a second pass or later in the line. Accordingly, after the second set of necking operations is completed and the diameter of the neck is smaller than after the first series of operations, a trimmer head 500 with a pilot having a smaller outside diameter may be utilized to interface with the now-smaller opening of the can/bottle. These two configurations of trimmer heads may be arrayed on a single turret, e.g., in sets of five, for example, to trim the cans during recirculation.

Accordingly, various size pilots may be utilized with the trimmer head 500 described herein based on the size of the opening of the can/bottle in which the waviness/earing is to be reduced or removed.

In some embodiments, the trimmer head 500 utilizes a standard milling head that may be used, for example, to “hog out” a piece of aluminum. The milling head is generally sized to be compatible with the general size of the can/bottle that is being trimmed, but in some embodiments, the same milling head (albeit with the appropriate size pilots) may be utilized to trim the can/bottle after the various necking operations. That is, by way of example only, referring to the above scenario, the same milling body design that is used to trim the necked can/bottle after the first series of necking operations may be used to trim the can/bottle after the second series of necking operations. In such situations, the difference in the trimmer heads 500 used in the two operations is the size of the pilot 40. However, in other embodiments, a different sized milling head may be utilized. In some embodiments, any size milling head, along with the properly sized pilot combined with that milling head, may be utilized, provided that the wavy portion/earing may be efficiently and satisfactorily reduced or removed.

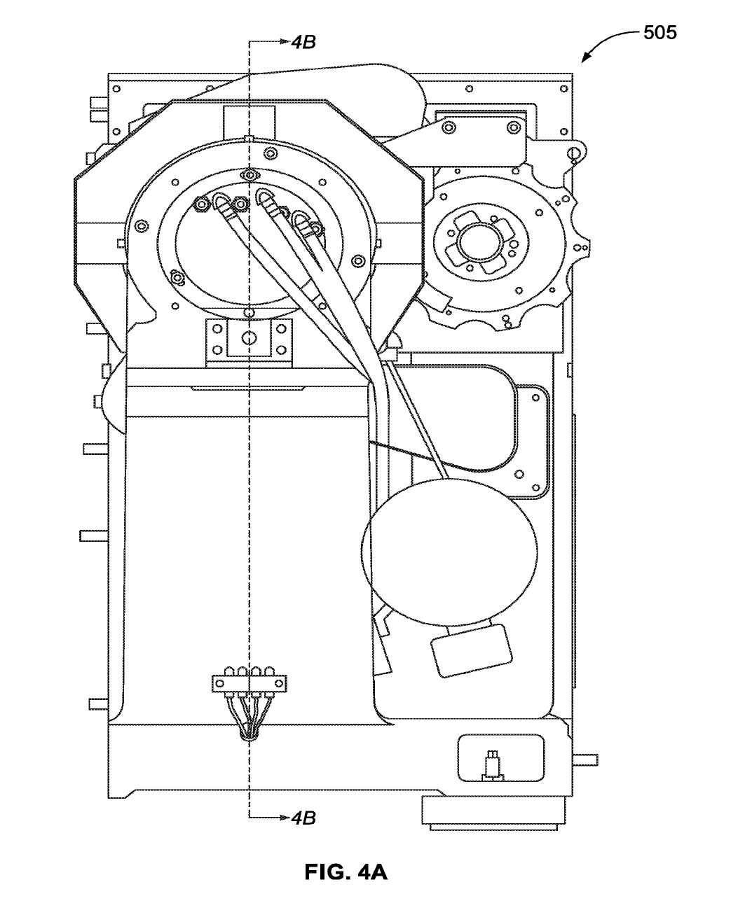

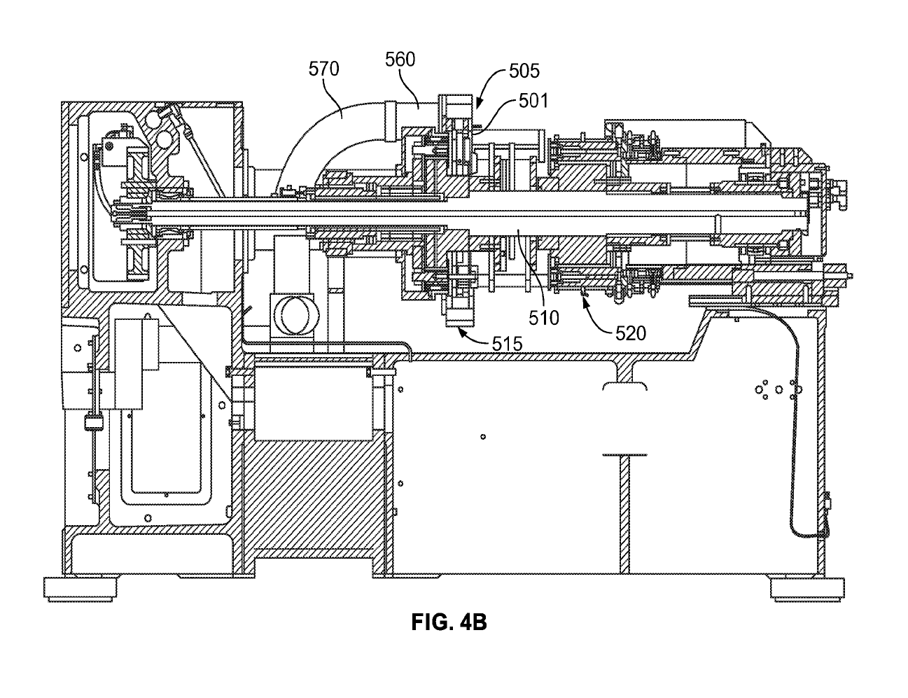

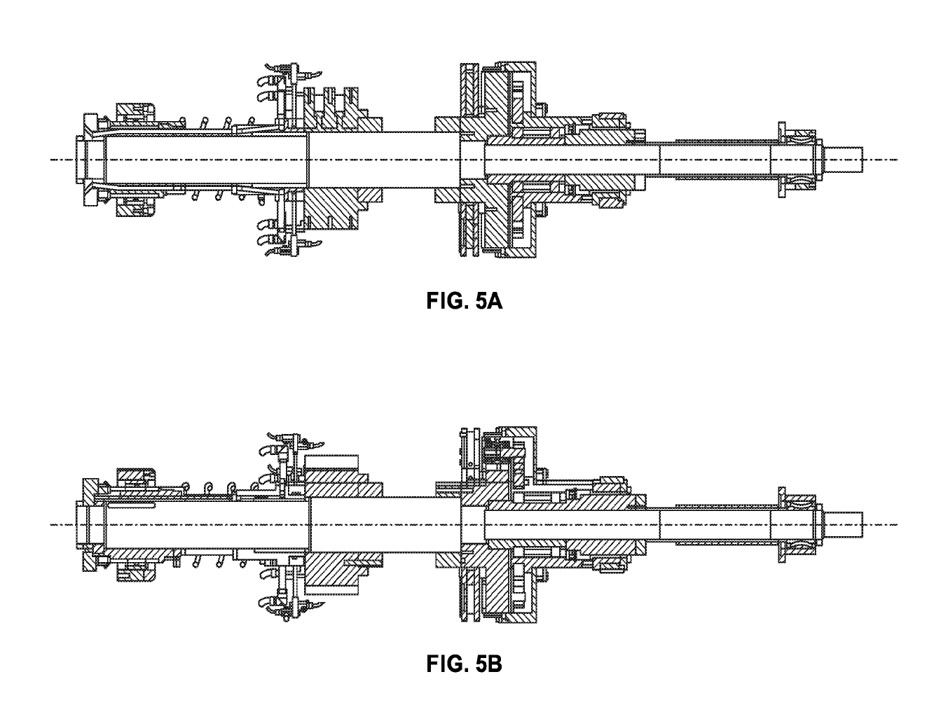

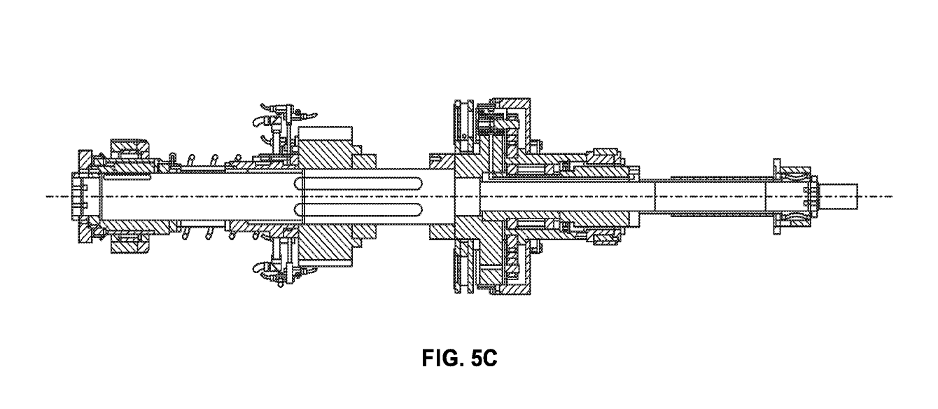

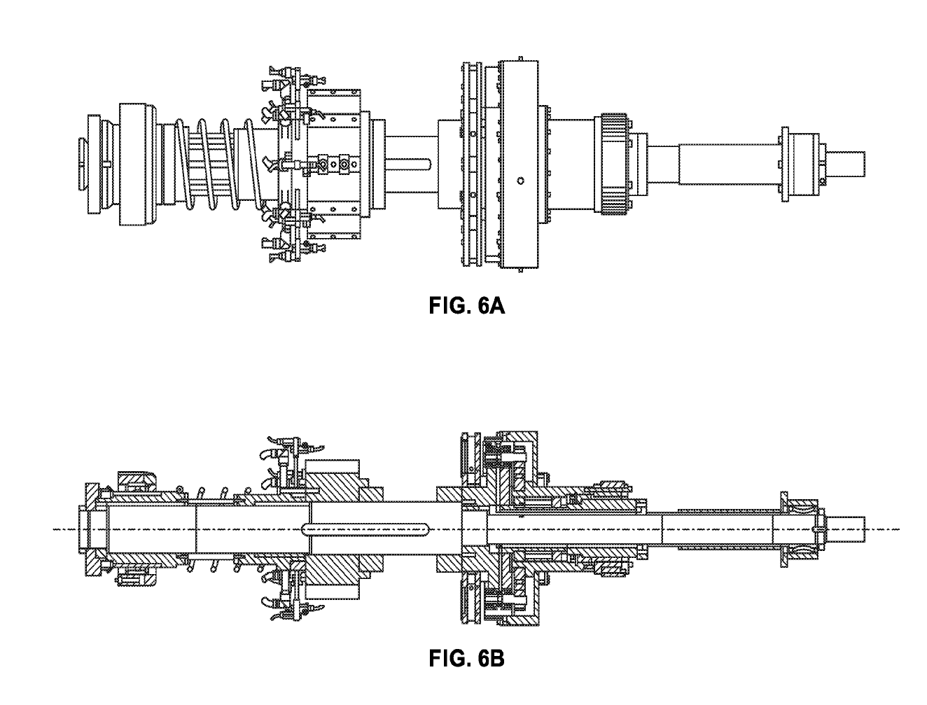

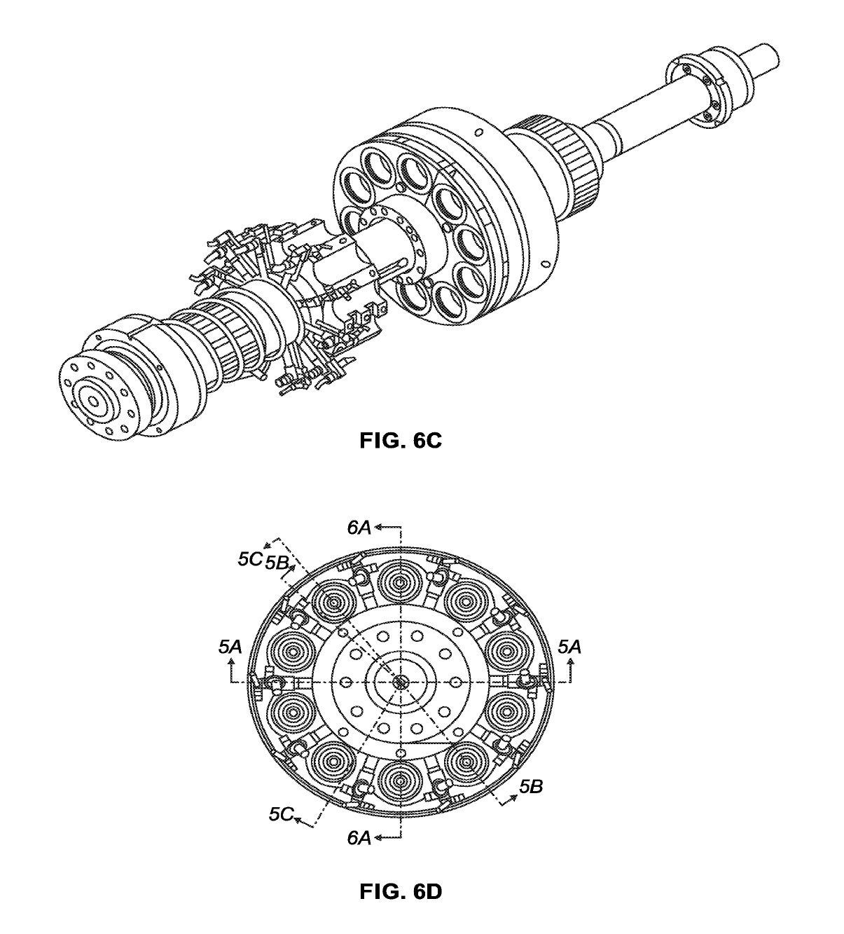

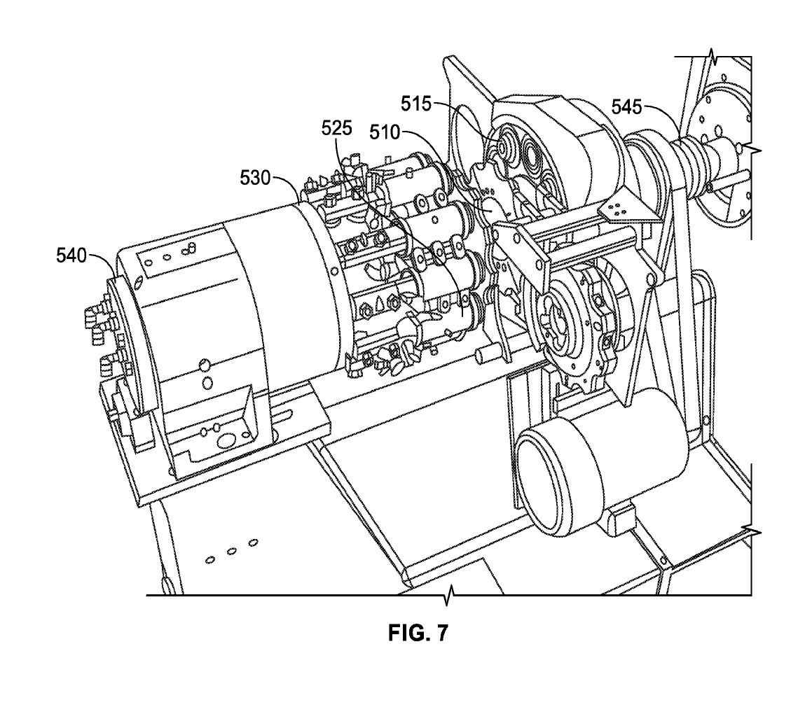

In some embodiments, the trimmer heads 500 are mounted in a trimming turret 501 of a trimming machine 505, such as that shown, by way of example only, in FIGS. 4-8. On the trimming turret 501 depicted in these figures, there are 10 locations for active trimmer heads (not shown), of which, e.g., five are used in a first pass and the other five are used in a second pass, in an alternating manner. The five trimmer heads used in the first pass have pilots with diameters greater than the pilots of the trimmer heads used in the second pass. In other embodiments, more or less locations are present on the trimming turret (an even number of locations being used on many embodiments to allow for two-pass execution).

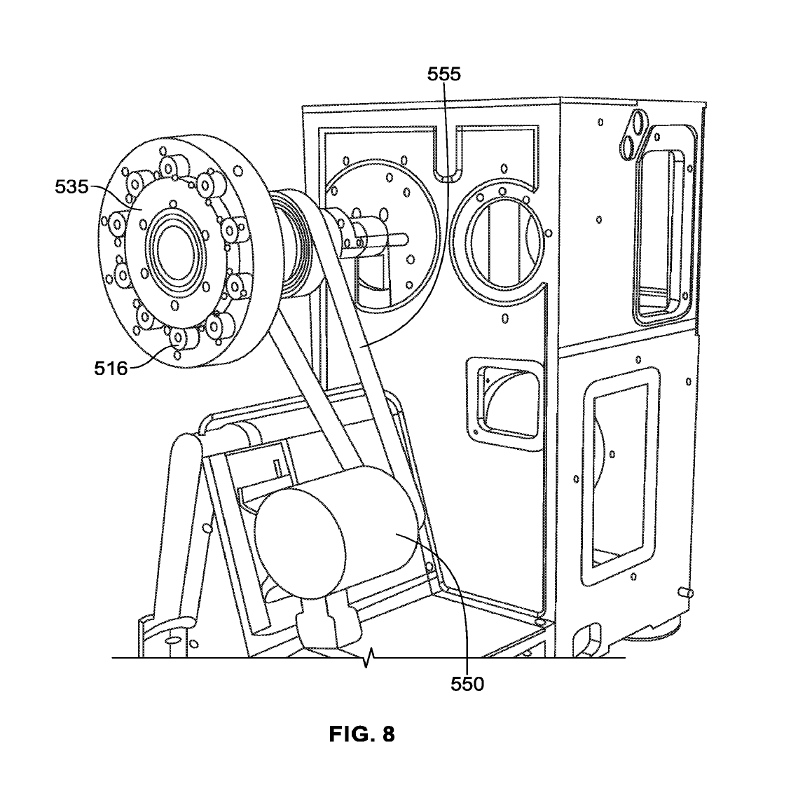

In some embodiments, the trimming turret 501 may include a main shaft 510, a housing with multiple trimming spindles 515 (which, in some embodiments, are configured to move towards a can/bottle, thus constituting a means for directing the trimming device to the container so that the pilot becomes located inside the opening), a housing 520 with multiple push ram assemblies 525 (which in some embodiments is a means for directing the container to the trimming device so that the pilot becomes located inside the opening), a cam 530 to actuate the push rams, a driven gear (e.g., a bull gear 535 of FIG. 8) to rotate the trimming spindles 515, a vacuum manifold 540 to deliver a vacuum to push plates that push the cans/bottles forward, and/or an air manifold 545 to pressurize the cans/bottles during trimming. In some embodiments, the trimming spindles 515 include a shaft mounted to a pair of bearings, a trimmer head 500 (as shown, by way of example, in FIGS. 1-2C), and a pinion gear to rotate the shaft mounted to the precision bearing, the shaft being connected to the trimmer head 500 such that the shaft rotates the trimmer head 500. In some embodiments, the turret 501 is a means for receiving a container having earing about a respective opening in the container.

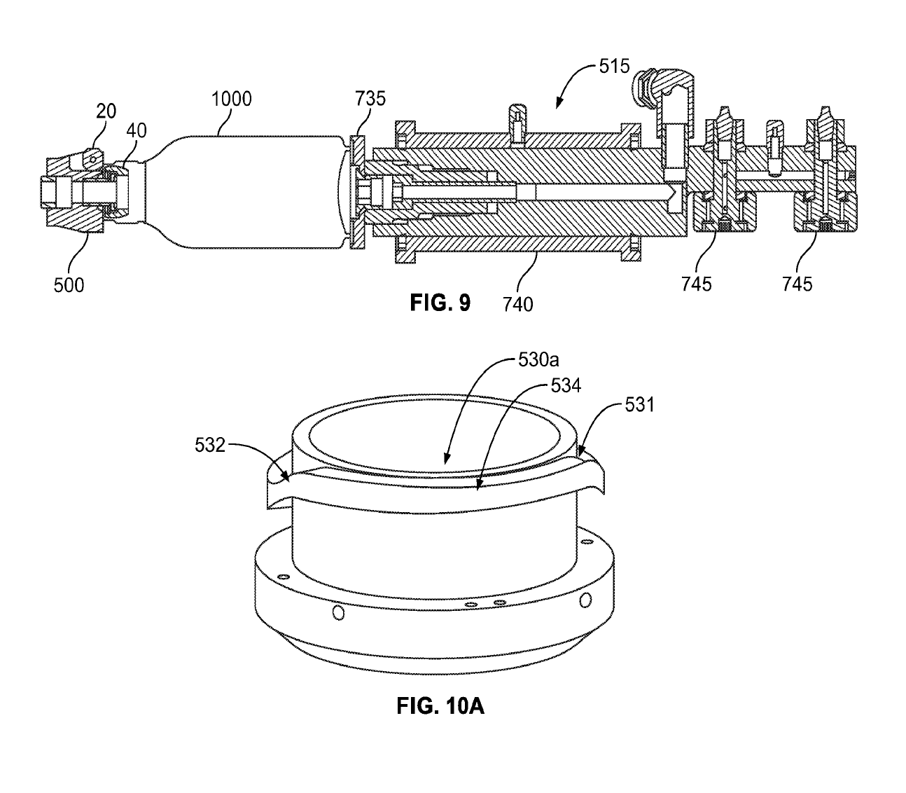

Referring to FIG. 9, a trimmer spindle assembly 515 is shown with the trimmer head 500 interfacing with a can 1000 to be trimmed. FIG. 9 also depicts, among other things, cam followers 745.

In some embodiments, the trimmer head 500 constantly spins/rotates. In some embodiments, the trimmer head 500 spins at a relatively high rate of rotational speed, while in still other embodiments, the trimmer head 500 rotates at a relatively low speed as compared to the higher speed. In some embodiments, the speed of the rotation of the trimmer head 500 may be controlled. In some embodiments, the bull gear 535 may be driven and rotated to adjust the rpm of the trimmer head 500. In some embodiments, the bull gear 535 may be counter-rotated to increase the rpm speed of the trimmer head 500. In general, when the speed of the trimmer head 500 is set at a high speed, long, stringy chips are produced from the trimmed can. In some embodiments, the speed of the trimmer head 500 may be adjusted to assist in controlling the sizes/shape and/or geometry of the chips that are produced during the trimming operation.

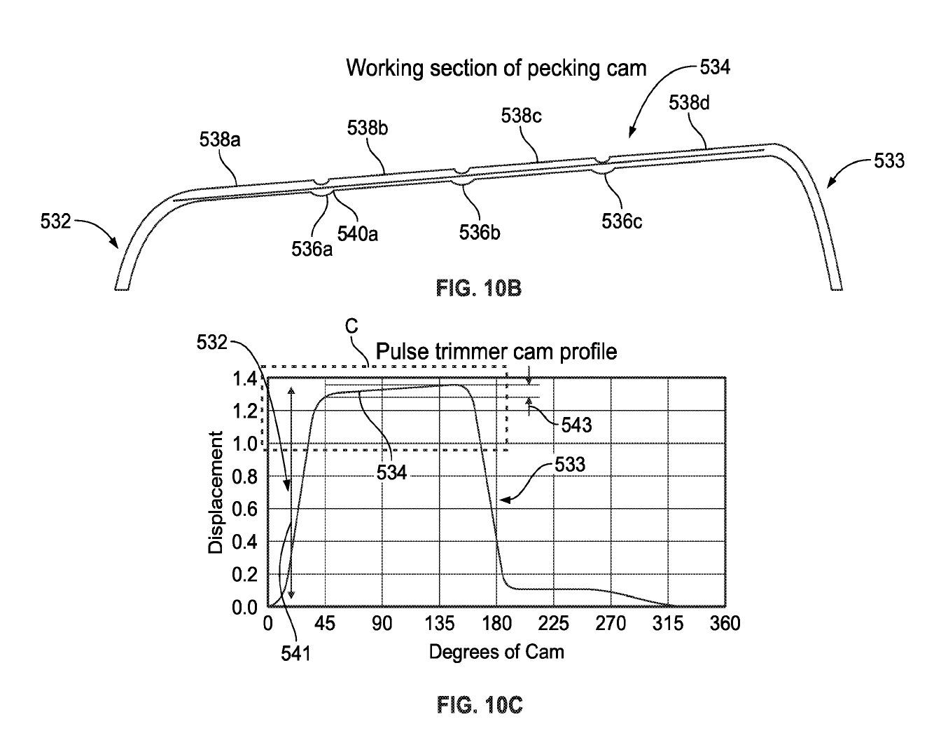

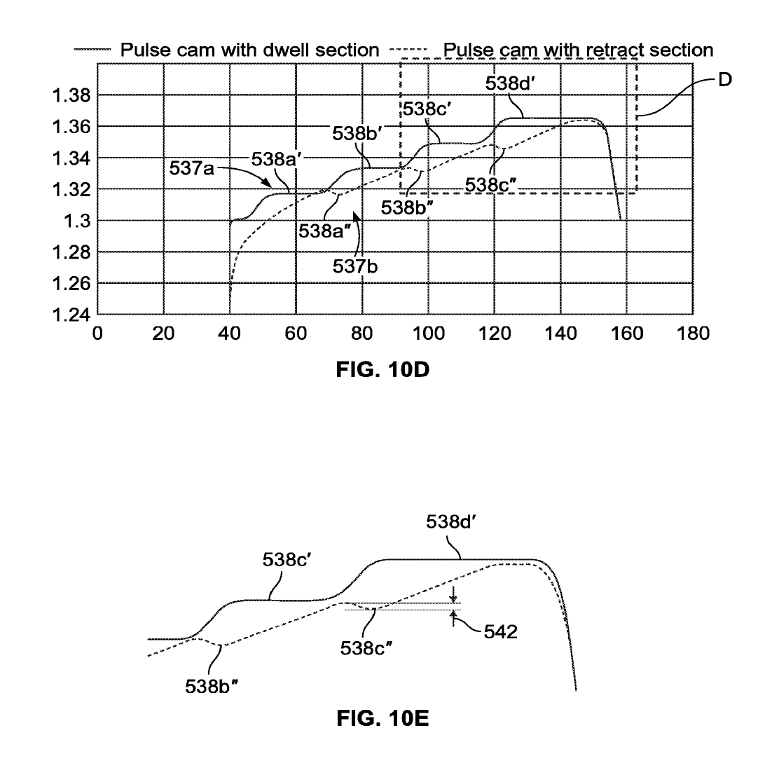

The feed rate at which the container is trimmed on the trimmer machine 505 is generally regulated by the cam 530, which has a constant velocity. According to the embodiments described herein, a pecking/pulsing cam 530a, as shown in FIG. 10A, may be implemented to vary the motion of which the container (e.g., can), which is coupled to a first end of a push ram 525, is presented to the trimmer head 500. The pulsing cam 530a described herein includes a cam profiled portion 531 for contacting the cam follower 745. The pulsing cam 530a is coupled to a second, generally opposing end of the push ram 525, thereby actuating the push ram 525. The profiled portion 531 of the pulsing cam 530a includes a generally sloped rising portion 532 that feeds the container in a first direction toward the trimmer head 500. The pulsing cam 530a further includes a generally sloped retracting portion 533 and a trimming or working portion 534 bridging top ends of the rising portion 532 and the retracting portion 533. The working portion 534 includes generally sloped sections (see sections 538a-538d of FIG. 10B) separated by at least one recess or dwell (see recesses 538a″-538c″ and dwells 538a′-538d′ of FIG. 10D). The slope of the sloped sections of the working portion 534 is generally substantially less than the slope of the rising portion 532 and/or the retracting portion 533. In one non-limiting embodiment, the overall height 543 of the working portion 534 (see FIG. 10C) may range from about 0.020 inches to about 0.200 inches.

FIG. 10B shows a close up view of the working portion 534 of the pulsing cam 530A according to one embodiment. In the illustrated embodiment, three recesses 536, 536b, 536c separate the working portion 534 into respective first, second, third, and fourth sloped sections 538a-538d. It is contemplated, however, that any suitable number of recesses and sloped sections may be included. FIG. 10C shows a graph illustrating the displacement of the push ram (and/or the container coupled thereto) as a function of the position (in degrees) of the cam follower coupled thereto around the pulsing cam 530a where, specifically, the working portion 534, the rising portion 532, and the retracting portion 533 are shown. FIG. 10D shows a close-up view of the working portion 534 (Section C) of FIG. 10C according to two other non-limiting embodiments. FIG. 10E shows a further close-up view of Section D of FIG. 10D.

Specifically, FIG. 10D shows two possible cam profiles 537a, 537b of the working portion 534 of a pulsing cam 530a according to non-limiting embodiments. The first cam profile 537a includes a plurality of dwells 538a′-538d′ that halt the motion of the push ram assembly in the first direction, thereby causing a trimmed earing or chip to detach or break away from the article. As such, a pulsing cam having the cam profile 537a uses a pause to detach the trimmed chip (instead of reverse motion).

The second cam profile 537b of FIG. 10D includes a plurality of recesses 538a″-538c″ that halt the motion of the push ram assembly in the first direction and slightly retract in a generally opposite second direction, thereby causing the trimmed earing or chip to detach or break away from the article. As such, a pulsing cam having the cam profile 537b detaches the trimmed chip from the article by a slight reverse motion. The distance that the push ram assembly moves in the second, reverse direction may range from about 0.001 inches to about 0.030 inches (as indicated by the peak-to-valley distance 542 of FIG. 10E).

Rotating the trimming turret 501 such that the cam follower 745 is actuated by the rising portion 532 of the pulsing cam 530a causes forward motion of the push ram and the container (e.g., the bottle can 32 of FIGS. 3A, 3B) coupled thereto a first distance in a first direction toward the trimmer head 500. Specifically, as discussed above, the trimmer head 500 receives the container so that the pilot 40 of the trimmer head 500 becomes located inside the opening (e.g., opening 36 of FIGS. 3A, 3B) of the container. At least one of the container and the trimmer head 500 is rotated such that the trimmer head 500 removes a first portion of the earing. As the trimming turret 501 continues to rotate, the cam follower contacts the at least one recess or dwell in the working portion 534 of the cam profile, causing the forward motion of the push ram and container coupled thereto to halt and/or slightly reverse. The halt and/or retraction away from the trimmer head 500 causes the cutting action to stop, which breaks the first portion of the earing (e.g., the trimmed material or chip), causing a first shaving or chip to detach from the article.

In embodiments where the push ram slightly reverses (as illustrated by the second cam profile 537b of FIG. 10D), the push ram and container are moved a second distance in a second, generally opposite direction away from the trimmer head 500. For efficiency, the second distance is generally substantially less than the first distance, e.g., is just enough to break contact between the edge/earing of the container and the trimmer head 500. For example, the peak-to-valley distance 542 of the recesses 536a-536c, 538a″-538c″ may range from about 0.001 inches to about 0.30 inches. The minimum stroke of the entire cam 531 may range from about 0.500 inches to about 5.00 inches, as indicated by element 541 of FIG. 10C. Thus, the container is configured to retract away in the second direction a greater distance from the trimmer head 500 when the cam follower 745 moves along the retracting portion 533 than when the cam follower 745 moves along the at least one recess 536a-536c, 538a″-538c″.

The cycle then repeats, e.g., the push ram assembly is moved again in the first direction via the cam follower 745 contacting a next section of the working portion 534 of the pecking cam 530a, thereby moving the push ram and container further in the first direction. The container again contacts the trimmer head 500, and at least one of the container or the trimmer head 500 may again be rotated such that a second portion of the edge/earing of the container is removed, thereby resulting in a second shaving or chip. The movement of the push ram assembly in the first direction is then halted via the cam follower contacting a second recess or dwell in the working portion of the cam profile. The halting causes the second portion of the edge/earing (the second shaving or chip) to detach from the article.

Once a desired amount of the earing is trimmed from the container and/or a desired amount of chips are obtained (via actuation by a corresponding number of sections 538 and corresponding recesses or dwells of the working portion 534), the push ram may be moved a third distance in the second direction away from the trimmer head 500 via the cam follower 745 contacting the retracting portion 533 of the cam profile.

The “pecking” or pulsing process described herein may be repeated as many times as desirable during a single trimming operation. The pulsing process allows the trimmed material to break or terminate and detach from the article, which creates smaller and/or shorter shavings or chips. The smaller and/or shorter chips are generally less prone to clogging and/or blocking the machine or portion thereof. Thus, the pulsing process described herein may produce, e.g., three or four shorter chip segments instead of a single, long chip.

In some embodiments, a feedback loop, system, or the like may be included to identify whether or not the chips and/or the sizes/shapes thereof are acceptable and, optionally, to automatically adjust parameters of the process (e.g., speed of the trimmer head) accordingly. By way of example and not by limitation, the feedback system may include a video camera or an optical system to determine/estimate the lengths of the shavings or chips, which may be in communication with a logic device that evaluates whether or not the chip size is acceptable/optimal and outputs a signal to increase or decrease the speed of the trimmer head accordingly.

As noted above, a motor may be utilized, optionally in communication with an automatic feedback system or simply under the control of a user, to control the speed of the bull gear and/or to impart a rotation onto the bull gear to change the rpm of the trimmer head, thus further assisting in controlling the types of chips produced. In some embodiments, the trimmer head 500 rotates to impart a trimming action to the non-rotating can/bottle. The required speed at which the trimmer head rotates in conjunction with the feed rate of the can/bottle moving into the trimmer head (generated by the cam profile 531 (see FIG. 10A)) may vary depending on the chip shape generated by the trimming action. Some variables that dictate the chip shape include, but are not limited to, material type and thickness. Thus, some embodiments utilize a variable speed trimmer head to further control the size and/or shape of the resulting chips.

Embodiments of the trimmer invention utilizing a bull gear will now be described in more detail.

With respect to FIGS. 4-8, in some embodiments, there are multiple trimmer heads (not shown) connected to trim spindles 515 that are arrayed around the trimming shaft, as discussed, for example, in U.S. Pat. No. 7,818,987, which is hereby incorporated by reference in its entirety. Each spindle 515 has a pinion, and that pinion (or rotation) gear 516 communicates with the bull gear 535. The bull gear 535, in some embodiments, is connected to a motor (such as, for example, the motor 550 depicted in FIG. 8) and may be counter-rotated to the direction of the actual shaft to increase the speed on the pinion gears 516. An operator may obtain increased speed of the pinions in this manner and, thus, obtain an increase in the speed of the trimmer heads 500. In some embodiments, the bull gear 535 may also be rotated in the same direction as the shaft. When the bull gear 535 is so rotated (in the same direction as the shaft), and when the bull gear 535 is rotated at the same speed as the shaft, no rotation of the trimmer heads is obtained. Conversely, if the bull gear 535 is rotated faster than the rotating speed of the shaft, rotation of the trimmer heads is obtained.

Thus, by varying motor speed and/or varying rotation of the bull gear, the speed of the trimmer head 500 may be controlled. As discussed above, in some embodiments, a feedback control system may be implemented to vary motor speed/rotation of the bull gear. As also discussed, trimmer head rpm control may be desirable because of the chip geometry that results from what is cut off the cans. The ability to control the speed of the trimmer head permits a user of the device to experiment with different chips to see which ones are easier to remove. Also, it permits the machine to be adjusted to take into account variations in the type of metal (e.g., various types of aluminum that may be used in cans) and/or sizes of the cans.

In one embodiment, the trimming turret 501 (see FIG. 4B) includes a vacuum 560, which helps remove the trimmed material (scrap) from the area of trimming. Specifically, the vacuum 560 utilizes a vacuum manifold and shroud assembly 570 that are positioned in sufficient proximity to the area of cutting to carry away the chips, e.g., by high speed airflow created by vacuum. In further embodiments, the interior of the cans are slightly pressurized (e.g., through the pilot) so as to decrease the likelihood of chips falling into the can. By way of example only and not by way of limitation, over-pressurization inside the can may “blow” air out of the top of the opening, thus entraining some or all of the chips that have a tendency to fall into the can, and blow those chips outward away from the interior of the can.

As noted above, in some embodiments, the cutter speed may be adjusted. By adjusting the cutter speed, a chip size may be produced that is conducive to being vacuumed up by the vacuum 560 (see FIG. 4B).

The movement of the can with respect to the trimming wheel will now be discussed. According to the embodiments described herein, a vacuum push plate 735 mounted to a push ram 740 assists in holding the can 1000 (see FIG. 9). The can 1000 is then introduced at a controlled rate and distance into/towards the rotating trimmer head 500, thus allowing the rotating trimmer head 500 to remove material from the opened edge of the can 1000. In some embodiments of the invention, the trimmer head 500 does not move along the axis of rotation, and the can 1000 is moved toward the trimmer head 500. The can 1000 may then be retracted from the trimmer head 500 by the vacuum push plate ram.

The present invention is not limited to the precise construction and compositions disclosed herein; any and all modifications, changes, and variations apparent from the foregoing descriptions are within the spirit and scope of the invention as defined by the appended claims. Moreover, the present concepts expressly include any and all combinations and subcombinations of the preceding features and aspects.

What is claimed:

1. A processing turret, comprising:
a trimmer head;
a cam, the cam including a cam profile having a generally sloped rising portion, a generally sloped retracting portion, and a working portion bridging top ends of the rising portion and the retracting portion, the working portion including generally sloped sections separated by at least one recess or dwell therein; and
a push ram assembly for moving an article, a first end of the push ram assembly including a feature for holding the article; and
a cam follower coupled to the push ram assembly at or near a second end of the push ram assembly, the cam follower being configured to be actuated by the cam,
wherein the trimmer head is configured to remove a first chip portion from an open end of the article when the cam follower contacts the generally sloped sections of the working portion of the cam, and the first chip portion is configured to be detached from the article when the cam follower contacts the at least one recess or dwell.

2. The processing turret of claim 1, wherein the trimmer head includes a pilot, the trimmer head being configured to receive the article so that the pilot becomes located inside the open end of the article when the cam follower contacts the working portion of the cam profile.

3. The processing turret of claim 1, wherein the at least one recess or dwell is a plurality of recesses or dwells.

4. The processing turret of claim 1, wherein the at least one recess or dwell is at least one recess, the peak-to-valley distance of the at least one recess is from about 0.001 inches to about 0.030 inches.

5. The processing turret of claim 1, wherein the at least one recess or dwell is at least one recess, the article being configured to retract away from the trimmer head when the cam follower contacts the at least one recess.

6. The processing turret of claim 5, wherein the article is configured to retract away from the trimmer head a greater distance when the cam follower moves along the retracting portion than when the cam follower moves along the at least one recess.

7. A cam for use in trimming earing from an open end of an article following at least one forming process, the cam comprising:
a cam profile for actuating a cam follower to which the article is coupled, the cam profile including
a generally sloped rising portion,
a generally sloped retracting portion, and
a working portion bridging the rising portion and the retracting portion, the working portion including generally sloped sections separated by at least one recess or dwell.

8. The cam of claim 7, wherein the at least one recess or dwell is a plurality of recesses or dwells.

9. The cam of claim 7, wherein the peak-to-valley distance of the at least one recess is from about 0.001 inches to about 0.030 inches.

10. The cam of claim 7, wherein the slope of the rising portion is greater than the slope of the sloped sections of the working portion.

11. A method of trimming earing from an open end of an article, the method comprising:
moving a push ram assembly having the article coupled to a first end thereof a first distance in a first direction such that the article contacts a trimmer head, the moving resulting from a cam follower coupled to a second end of the push ram assembly moving along a generally sloped rising portion of the profile of a cam, the profile further including a generally sloped retracting portion and a working portion bridging top ends of the rising portion and the retracting portion, the working portion including generally sloped sections separated by at least one recess or dwell;
rotating at least one of the article or the trimmer head such that the trimmer head removes a first chip portion from the open end of the article, the removing occurring when the cam follower moves along a first section of the working portion of the cam profile;
halting the movement of the push ram assembly in the first direction via the cam follower contacting the at least one recess or dwell in the working portion of the cam profile, the halting causing the first chip portion to detach from the article;
moving the push ram assembly having the article coupled thereto in the first direction via the cam follower contacting a second section of the working portion of the cam profile;
rotating at least one of the article or the trimmer head such that the trimmer head removes a second chip portion from the open end of the article, the removing occurring when the cam follower moves along the second section of the working portion of the cam profile; and
halting the movement of the push ram assembly in the first direction via the cam follower contacting a second recess or dwell in the working portion or the retracting portion of the cam profile, the halting causing the second chip portion to detach from the article.

12. The method of claim 11, wherein the trimmer head includes a pilot, the trimmer head receiving the article so that the pilot becomes located inside the open end of the article when the cam follower contacts the working portion of the cam profile.

13. The method of claim 11, wherein the at least one recess or dwell is a plurality of recesses or dwells.

14. The method of claim 11, wherein the at least one recess or dwell is at least one recess, the peak-to-valley distance of the at least one recess is from about 0.001 inches to about 0.030 inches.

15. The method of claim 11, wherein the at least one recess or dwell is at least one recess, the article retracting away from the trimmer head when the cam follower contacts the at least one recess.

16. The processing turret of claim 15, wherein the article is retracts away from the trimmer head a greater distance when the cam follower moves along the retracting portion than when the cam follower moves along the at least one recess.
